(19) United States
(12) Patent Application Publication
(10) Pub. No.: US 2026/0159699 A1
(43) Pub. Date: Jun. 11, 2026

(54) AQUEOUS DISPERSION OF OPACIFYING PIGMENT-BINDER HYBRID POLYMER PARTICLES

(71) Applicant: Rohm and Haas Company, Collegeville, PA (US)

(72) Inventor: Michael W. Leonard, Collegeville, PA (US)

(21) Appl. No.: 18/707,201

(22) PCT Filed: Nov. 18, 2022
(86) PCT No.: PCT/US2022/050362

§ 371 Date: May 3, 2024

Related U.S. Application Data
(60) Provisional application No. 63/281,759, filed on Nov. 22, 2021.

(51) Int. Cl. C09D 4/06; C09D 7/40; C09D 7/65; C09D 133/06; C09D 133/12; C09D 133/14

(52) U.S. Cl. CPC C09D 4/06; C09D 7/65; C09D 7/70; C09D 133/064; C09D 133/12; C09D 133/14

(57) ABSTRACT

The present invention relates to a composition comprising an aqueous dispersion of polymer particles comprising a water-occluded core: a polymeric shell comprising structural units of methyl methacrylate, styrene, and trimethylolpropane trimethacrylate; and a film-forming polymeric binder layer. The composition of the present invention provides opacifying pigment-binder hybrid particles with a high scattering coefficient, acceptable collapse resistance, and a substantial absence of acrylonitrile functionalization. The composition of the present invention is useful for reducing the level in TiO₂ usage in paints.

### BACKGROUND OF THE INVENTION

The present invention relates to an aqueous dispersion of opacifying pigment-binder hybrid particles, more particularly, hybrid particles that are substantially free of acrylonitrile.

Opaque polymers (OPs) are organic opacifying pigment particles that help reduce the loading of titanium dioxide (TiO₂) in paint formulations. (See U.S. Pat. Nos. 6,020,435 and 10,919,999.) OPs coated with film-forming binder particles (opacifying pigment-binder hybrid polymer particles), for example, opaque acrylic polymers (OAPs) as disclosed in U.S. Pat. No. 7,629,414 B2, have been reported to provide increased opacity when incorporated into coatings formulations. OAPs functionalized with repeat units of acrylonitrile (AN) give especially desirable chemical and collapse resistance. However, acrylonitrile is hazardous to handle and classified as a probable carcinogen in humans. Moreover, there is still a need in the art to improve the scattering coefficient (hiding) of collapse resistant OAPs, which are not reported to exceed 1.05 S/mil. It would therefore be desirable to prepare OAPs acceptable collapse properties and improved hiding without the use of objectionable monomers such as AN.

### SUMMARY OF THE INVENTION

The present invention addresses a need in the art of organic opacifying pigments by providing a composition comprising an aqueous dispersion of:
a) multistage polymer particles comprising 1) a water-occluded core comprising from 20 to 60 weight percent structural units of a salt of a carboxylic acid monomer and from 40 to 80 weight percent structural units of a nonionic monoethylenically unsaturated monomer; 2) a polymeric shell having a calculated T_{g} in the range of from 90° C. and 110° C.; and 3) a film-forming polymeric binder layer superposing the shell, wherein the polymeric binder layer comprises structural units of at least one monoethylenically unsaturated monomer and has a T_{g} of not greater than 35° C.; wherein:
i) at least 95 weight percent of the shell comprises structural units of methyl methacrylate, styrene, and trimethylolpropane trimethacrylate;
ii) the shell comprises from 0.5 to 6 weight percent structural units of trimethylolpropane trimethacrylate;
iii) the weight-to-weight ratio of the structural units of methyl methacrylate to styrene in the shell is in the range of from 35:65 to 55:45;
iv) the ratio of the weight of structural units of monomers of the core to the weight of the shell in the multistage polymer particles is in the range of 1:12 to 1:16;
v) the weight-to-weight ratio of the polymer binder to the sum of the weight of the shell and the weight of the structural units of monomers in the core in the multistage polymer particles is in the range of 1:1 to 3.5:1;
vi) the shell comprises less than 2 weight percent structural units of acrylonitrile; and
vii) the z-average particle size of the multistage polymer particles is in the range of from 300 nm to 750 nm.

The composition of the present invention addresses a need in the art by providing organic opacifying pigment particles with acceptable collapse resistance and hiding properties.

### DETAILED DESCRIPTION OF THE INVENTION

The present invention is a composition comprising an aqueous dispersion of:
a) multistage polymer particles comprising 1) a water-occluded core comprising from 20 to 60 weight percent structural units of a salt of a carboxylic acid monomer and from 40 to 80 weight percent structural units of a nonionic monoethylenically unsaturated monomer; 2) a polymeric shell having a calculated T_{g} in the range of from 90° C. and 110° C.; and 3) a film-forming polymeric binder layer superposing the shell, wherein the polymeric binder layer comprises structural units of at least one monoethylenically unsaturated monomer and has a T_{g} of not greater than 35° C.; wherein:
i) at least 95 weight percent of the shell comprises structural units of methyl methacrylate, styrene, and trimethylolpropane trimethacrylate;
ii) the shell comprises from 0.5 to 6 weight percent structural units of trimethylolpropane trimethacrylate;
iii) the weight-to-weight ratio of the structural units of methyl methacrylate to styrene in the shell is in the range of from 35:65 to 55:45;
iv) the ratio of the weight of structural units of monomers of the core to the weight of the shell in the multistage polymer particles is in the range of 1:12 to 1:16;
v) the weight-to-weight ratio of the polymer binder to the sum of the weight of the shell and the weight of the structural units of monomers in the core in the multistage polymer particles is in the range of 1:1 to 3.5:1;
vi) the shell comprises less than 2 weight percent structural units of acrylonitrile; and
vii) the z-average particle size of the multistage polymer particles is in the range of from 300 nm to 750 nm.

The water-occluded core comprises from 20, preferably from 25, more preferably from 30, and most preferably from 32 weight percent, to 60, preferably to 50, more preferably to 40, and most preferably 36 weight percent structural units of a salt of a carboxylic acid monomer based on the weight of structural units of monomers in the core.

As used herein, the term “structural units” refers to the remnant of the recited monomer after polymerization. For example, a structural unit of a salt of methacrylic acid is as illustrated:

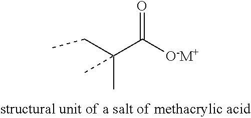

where M⁺ is a counterion, preferably a lithium, sodium, or potassium counterion. Examples of suitable carboxylic acid monomers include acrylic acid, methacrylic acid, itaconic acid, and maleic acid.

The water-occluded core further comprises from 40, preferably from 50, more preferably from 55, more preferably from 60, and most preferably from 64 weight percent to 80, preferably to 75, more preferably to 70, and most preferably to 68 weight percent structural units of a nonionic monoethylenically unsaturated monomer based on the weight of structural units of monomers in the core. Examples of nonionic monoethylenically unsaturated monomers include one or more acrylates and/or methacrylates such as methyl acrylate, ethyl acrylate, n-butyl acrylate, t-butyl acrylate 2-ethylhexyl acrylate, methyl methacrylate, n-butyl methacrylate, t-butyl methacrylate, isobutyl methacrylate, isobornyl methacrylate, lauryl methacrylate, and cyclohexyl methacrylate; and one or more monoethylenically unsaturated aromatic compounds such as styrene, α-methylstyrene, and 4-t-butylstyrene. A preferred nonionic monoethylenically unsaturated monomer is methyl methacrylate.

The polymeric shell of the multistage polymer particles has a calculated T_{g} in the range of from than 90° C. to 110° C. As used herein, calculated T_{g} refers to the glass transition temperature as calculated by the Fox equation.

The shell comprises structural units of methyl methacrylate and styrene at a weight-to-weight ratio of from 35:65 or from 40:60, to 55:45 or to 50:50; preferably, methyl methacrylate and styrene comprise at least 90 weight percent of the shell. The shell further comprises from 0.5 or from 1 or from 2 weight percent, to 6 or to 5 or to 4 weight structural units of trimethylolpropane trimethacrylate, based on the weight of the shell.

The shell further comprises less than 2, or less than 1 or less than 0.5 or less than 0.1 or 0 weight percent structural units of acrylonitrile (AN), and the multistage polymer particles preferably comprise less than 1, or less than 0.5, or less than 0.1, or 0 weight percent structural units of AN.

Similarly, the shell and the multistage particles preferably comprise less than 1, or less than 0.5, or less than 0.1, or 0 weight percent structural units of divinyl benzene (DVB).

As used herein, “polymeric binder” refers to a polymeric material that is film forming on a desired substrate, with or without a coalescent. In one aspect, the T_{g} of the polymeric binder as calculated by the Fox equation is not greater than 25° C.; or not greater than 15° C., or not greater than 10° C., and in another aspect not less than −20° C., or not less than −10° C.

Examples of suitable polymeric binder materials include acrylic, styrene-acrylic, vinyl esters such as vinyl acetate and vinyl versatates, and vinyl ester-ethylene polymeric binders. Acrylic binders comprising structural units of methyl methacrylate and structural units of one or more acrylates such as methyl acrylate, ethyl acrylate, n-butyl acrylate, and 2-ethylhexyl acrylate, are especially preferred. The binder may comprise additional monomers such as acetoacetoxyethyl methacrylate (AAEM), carboxylic acid monomers, sulfonic acid monomers, and phosphorus acid monomers.

The ratio of the weight of structural units of monomers of the core to the weight of the shell in the multistage polymer particles is in the range of 1:12 to 1:16. The weight-to-weight ratio of the polymer binder to the sum of the weight of the shell and the weight of the structural units of monomers of the core in the multistage polymer particles is in the range of from 1:1, or from 1.2:1, or from 1.5:1, to 3.5:1, or to 3.0:1, or to 2.5:1, or to 2.2:1, or to 2.0:1.

The z-average particle size of the multistage polymer particles is in the range of from 300 nm, or from 400 nm, or from 450 nm, or from 475 nm, to 750 nm, or to 700 nm, more preferably 600 nm, and most preferably to 550 nm. As used herein, z-average particle size refers to particle size as determined by dynamic light scattering, for example using a BI-90 Plus Particle Size Analyzer (Brookhaven).

The composition of the present invention can be prepared, for example, as disclosed in U.S. Pat. No. 7,629,414 and WO 2021/225769. Prior to the present discovery, no aqueous dispersions of opacifying pigment-binder hybrid polymer particles with less than 10% collapse and scattering coefficient of at least 1.2 S/mil were reported without the use of both acrylonitrile (AN) and divinyl benzene (DVB), which is also hazardous and difficult to handle. Accordingly, in another aspect, the composition of the present invention, when applied to a substrate and allowed to dry, has a Kubelka-Munk scattering coefficient of at least 1.2, or from 1.5, or from 1.7 S/mil to 3.0 or to 2.5 S/mil, and a collapse of less than 10%. The preparation of an aqueous dispersion of opacifying pigment-binder hybrid polymer particles, more particularly OAPs, with acceptable collapse resistant and hiding properties without the use of AN or DVB, represents a significant contribution to the field of organic opacifying pigments.

The composition may further include other materials such as binders, inorganic opacifying pigments, coalescents, rheology modifiers, surfactants, defoamers, and extenders.

### EXAMPLES

### Kubelka-Munk Scattering Coefficient Measurement

The scattering coefficient (S/Mil) is a measure of the opacity of the OAPs. A sample of aqueous dispersion of OAPs was blended with RHOPLEX™ AC-264 Emulsion Polymer (AC-264, A Trademark of The Dow Chemical Company or its Affiliates) at a weight-to-weight ratio of 15:85 OAP: AC-264 based on solids. A 7-mil wet film of the blend was drawn over a sheet of black vinyl that was measured for thickness in four small defined areas with an Ames Gauge. The film was dried for 2 h at low relative humidity (<40% R.H.). The reflectance of the dry film was measured by a Gardner Instrument Reflectometer over the four defined areas. The thickness of the dried film was also determined over the same defined areas using the Ames Gauge. The Scattering coefficient was calculated for each of defined areas as:

$$S / mil = 1 - ( \frac{R}{( 1 - R ) \times T} ) \times 100$$

where R is Reflectance and T is film thickness in mils. The four S/Mil measurements were then averaged to obtain the S/Mil for the film.

### Collapse

Collapse is an indication of the ability of an opaque polymer to resist the forces of drying acting on the walls of the internal micro void. These forces are greatest at high humidity, which causes the particles to dry slowly. Collapse is determined using essentially the same procedure that is used in determining S/Mil above except that a second drawdown is dried overnight at 75% R.H., then dried at <40% R.H. for 1 h.

$$\% Collapse = 1 - ( \frac{High humidity S / mil}{Low humidity S / mi} ) \times 100$$

In the following Examples, Core #1 refers to an aqueous dispersion of polymer particles (66 MMA/34 MAA, solids 32.0%, z-average particle size of 135 nm) prepared substantially as described in U.S. Pat. No. 6,020,435.

### Comparative Example 1—Preparation of an Aqueous Dispersion of Binder Coated Multistage Polymer Particles with Shell Functionalized with Acrylonitrile and Divinyl Benzene

A 5-liter, four necked round bottom flask was equipped a paddle stirrer, thermometer, N₂ inlet and reflux condenser. DI water (475 g) was added to the flask and heated to 89° C. under N₂. Sodium persulfate (NaPS, 3 g in 25 g water) was added to flask immediately followed by Core #1 (125 g). Monomer emulsion 1 (ME 1), which was prepared by mixing DI water (125.0 g), Disponil FES-32 emulsifier (FES-32, 10.0 g), styrene (424.2 g), methacrylic acid (7.0 g), linseed oil fatty acid (2.8 g), acrylonitrile (112.0 g), and divinyl benzene (14.0 g), was then added to the flask over 45 min. The temperature of the reaction mixture was allowed to increase 84° C. after 15 min and allowed to increase to 92° C. after 25 min. Two minutes after the start of ME 1 addition, a solution of methacrylic acid (5.6 g) in DI water (40 g) was added to the flask. Upon completion of the ME 1 addition, the reaction was cooled to 60° C.

When the contents of the flask reached 80° C., an aqueous mixture of ferrous sulfate and EDTA (20 g, 0.1 wt. % FeSO₄, and 2 g, 1 wt. % EDTA) was added to the flask. When the contents reached 60° C., co-feeds including a solution of t-butylhydroperoxide (1-BHP 1.9 g) and NaPS (5.0 g) mixed with DI water (100 g), along with a separate solution of isoascorbic acid (IAA, 2.6 g in 100 g water) were both added simultaneously to the flask at 1.2 g/mins. Two min after the start of charging the co-feed solutions, ME 2, which was prepared by mixing DI water (240 g), FES-32 emulsifier (17.0 g), n-butyl acrylate (431.46 g), methyl methacrylate (430.5 g), 2-ethylhexyl acrylate (124.4 g), acetoacetoxyethyl methacrylate (25.5 g) and methacrylic acid (8.0 g), was added to the flask over 55 min while allowing the temperature to rise to 86° C. without providing any external heat. Upon completion of ME 2 addition, the co-feed solutions were stopped and the batch was held for 5 min at 80° C. to 86° C. A solution of NH₄OH (5 g, 28 wt. % aq.) mixed with DI water (5.0 g) was then added to the flask along with hot (90° C.) DI water (175 g).

ME 3, which was prepared by mixing DI water (54.0 g), Disponil FES-32 emulsifier (3.0 g), n-butyl acrylate (104.4 g), methyl methacrylate (75.6 g), and 4-hydroxy TEMPO (3.0 g), was fed to the flask over 5 min. Immediately after the ME 3 feed addition was complete, NH₄OH (35.0 g, 28 wt. % aq.) mixed with DI water (35 g) was added to the flask over 2 min. When NH₄OH addition was complete, the batch was held for 5 min. The addition the co-feed solutions was resumed at 1.2 g/min until completion, whereupon the dispersion was cooled to 25° C. While cooling, additional co-feeds including a solution of 1-BHP (1.5 g) in DI water (25 g), along with a separate solution of IAA (0.7 g) in water (25 g) were both added simultaneously to the flask at a rate of 1.30 g/min. Upon completion of addition of the second co-feed, the dispersion was filtered to remove any coagulum. The filtered opaque acrylic dispersion (OAP) had a solids content of 48.7%. The S/mil was measured to be 1.03 with collapse of 0.0%.

### Comparative Example 2—Preparation of an Aqueous Dispersion of Binder Coated Multistage Polymer Particles with Shell Functionalized with 20% Methyl Methacrylate

The procedure was carried out substantially as described in Comparative Example 1, except that ME 1 was prepared by mixing DI water (127.8 g), FES-32 emulsifier (10.0 g), styrene (421.4 g), methacrylic acid (7.0 g), linseed oil fatty acid (2.8 g), methyl methacrylate (112.0 g), and trimethylolpropane trimethacrylate (14.0 g). The filtered opaque acrylic dispersion (OAP) had a solids content of 48.8%. The S/mil was measured to be 1.67 with collapse of 41.0%.

### Comparative Example 3—Preparation of an Aqueous Dispersion of Binder Coated Multistage Polymer Particles with Shell Functionalized with 60% Methyl Methacrylate

The procedure was carried out substantially as described in Comparative Example 1, except as follows: ME 1 was prepared by mixing DI water (127.8 g), FES-32 emulsifier (10.0 g), styrene (197.4 g), methacrylic acid (7.0 g), linseed oil fatty acid (2.8 g), methyl methacrylate (336.0 g), and trimethylolpropane trimethacrylate (14.0 g), was then added to the flask over 45 min. Two min after the start of ME 1 addition, a solution of methacrylic acid (5.6 g) in DI water (40 g) was added to the flask. Upon completion of the ME 1 feed, the reaction was cooled to 60° C. The filtered opaque acrylic dispersion (OAP) had a solids content of 48.7%. The S/mil was measured to be 1.07 with collapse of 23.9%.

### Example 1—Preparation of an Aqueous Dispersion of Binder Coated Multistage Polymer Particles with Shell Functionalized with 40% Methyl Methacrylate

A 5-liter, four necked round bottom flask was equipped a paddle stirrer, thermometer, N₂ inlet and reflux condenser. DI water (475 g) was added to the flask and heated to 89° C. under N₂. Sodium persulfate (NaPS, 1.38 g in 30 g water) was added to the flask immediately followed by Core #1 (125 g). ME 1, which was prepared by mixing DI water (40.0 g), FES-32 emulsifier (3.0 g), styrene (40.0 g), methacrylic acid (4.8 g), and methyl methacrylate (35.2 g), was then added to the flask over 40 min at a constant temperature range of 77° C. to 79° C. Upon completion of ME 1 addition, ME 2, which was prepared by mixing DI water (110.0 g), FES-32 emulsifier (8.66 g), styrene (264.0 g), methacrylic acid (7.2 g), linseed oil fatty acid (2.4 g), methyl methacrylate (192.0 g), and trimethylolpropane trimethacrylate (16.8 g), was then added to the flask over 40 min with a simultaneous co-feed solution of NaPS (0.4 g in 30 g water) added to the flask over 35 min. The temperature of the reaction mixture was immediately allowed to increase to 84° C., then allowed to increase to 92° C. after 15 min. Upon completion of the ME 2 feed, the reaction was cooled to 50° C.

When the reaction mixture reached 80° C., an aqueous mixture of ferrous sulfate and EDTA (20 g, 0.1 wt. % FeSO₄, and 2 g, 1 wt. % EDTA) was added to the flask. When the reaction mixture reached 50° C., co-feeds including a solution of t-BHP (1.9 g) and NaPS (5.0 g) mixed with DI water (100 g), along with a separate solution of IAA (2.6 g in 100 g water) were both added simultaneously to the flask at 1.2 g/min. Two min after the start of charging the co-feed solutions, ME 3, which was prepared by mixing DI water (240 g), FES-32 emulsifier (17.0 g), n-butyl acrylate (431.4 g), methyl methacrylate (430.6 g), 2-ethylhexyl acrylate (124.4 g), acetoacetoxyethyl methacrylate (25.5 g) and methacrylic acid (8.0 g), was added to the flask over 55 min while allowing the reaction mixture temperature to rise to 86° C. without providing any external heat. Upon completion of ME 3 addition, the co-feed solutions were stopped and the batch was held for 5 min at 80° C. to 86° C. A solution of NH₄OH (5 g, 28 wt. % aq.) mixed with DI water (5.0 g) was then added to the flask along with hot (90° C.) DI water (175 g).

ME 4, which was prepared by mixing DI water (54.0 g), FES-32 emulsifier (3.0 g), n-butyl acrylate (104.4 g), methyl methacrylate (75.6 g), and 4-hydroxy TEMPO (3.0 g), was fed to the flask over 5 min. Immediately after the ME 4 feed addition was complete, NH₄OH (35.0 g, 28 wt. % aq.) mixed with DI water (35 g) was added to the flask over 2 min. When NH₄OH addition was complete, the batch was held for 5 min. The addition the co-feed solutions was resumed at 1.2 g/min until completion, whereupon the dispersion was cooled to 25° C. While cooling, additional co-feeds including a solution of 1-BHP (1.5 g) in DI water (25 g), along with a separate solution of IAA (0.7 g) in water (25 g) were both added simultaneously to the flask at a rate of 1.3 g/min. Upon completion of addition of the second co-feed, the dispersion was filtered to remove any coagulum. The filtered opaque acrylic dispersion (OAP) had a solids content of 48.1%. The S/mil was measured to be 1.73 with collapse of 7.4%.

### Example 2—Preparation of an Aqueous Dispersion of Binder Coated Multistage Polymer Particles with Shell Functionalized with 40% Methyl Methacrylate

The reaction was carried out substantially as described in Example 1, except that 700 g DI water was added to in the initial flask charge prior to the addition of ME 1, no NH₄OH was added prior to the ME 4 step, no hot DI water was added prior to the ME 4 addition step, and 40 g of NH₄OH was added immediately after the ME 4 feed was complete. The filtered opaque acrylic dispersion (OAP) had a solids content of 47.9%. The S/mil was measured to be 1.54 with collapse of 2.3%.

### Example 3—Preparation of an Aqueous Dispersion of Binder Coated Multistage Polymer Particles with Shell Functionalized with 40% Methyl Methacrylate

In this example ME 1 and ME 2 from Example 1 were combined in a single step by mixing DI water (110 g), FES-32 emulsifier (8.7 g), styrene (308.0 g), linseed oil fatty acid (2.4 g), methyl methacrylate (223.95 g), and trimethylolpropane trimethacrylate (19.6 g). The temperature of the reaction mixture was allowed to increase to 84° C. after 15 min, and allowed to increase to 92° C. after 25 min. Two minutes after the start of ME 1 addition, a solution of methacrylic acid (8.4 g) in DI water (50 g) was added to the flask. Upon completion of the ME 1 feed, the reaction mixture was cooled to 50° C. The remainder of the polymerization was carried out substantially as described in Example 1. The filtered opaque acrylic dispersion (OAP) had a solids content of 47.9%. The S/mil was measured to be 1.64 with collapse of 9.4%.

### Example 4—Preparation of an Aqueous Dispersion of Binder Coated Multistage Polymer Particles with Shell Functionalized with 40% Methyl Methacrylate and Vinyltrimethoxysilane

The process was carried out substantially as described in Example 1, except that ME 3 was prepared by mixing DI water (240 g), FES-32 emulsifier (17.0 g), n-butyl acrylate (431.4 g), methyl methacrylate (426.2 g), 2-ethylhexyl acrylate (124.4 g), acetoacetoxyethyl methacrylate (25.5 g), vinyltrimethoxysilane (4.4 g), and methacrylic acid (8.0 g). The filtered opaque acrylic dispersion (OAP) had a solids content of 47.8%. The S/mil was measured to be 1.81 with collapse of 8.4%.

### Example 5—Two-Stage Preparation of an Aqueous Dispersion of Binder Coated Multistage Polymer Particles with Shell Functionalized with 40% Methyl Methacrylate

ME 1, which was prepared by mixing DI water (200 g), FES-32 emulsifier (10.0 g), styrene (307.95 g), linseed oil fatty acid (2.4 g), methyl methacrylate (223.95 g), and trimethylolpropane trimethacrylate (19.6 g), was added to the flask as described in Example 3 over 60 min. The temperature of the reaction mixture was allowed to increase to 84° C. after 30 min and allowed to increase to 92° C. after 45 min. Two minutes after the start of ME 1 addition, a solution of methacrylic acid (8.4 g) in DI water (35 g) was added to the flask. Upon completion of the ME 1 feed, the reaction was cooled to 50° C.

When the reaction mixture temperature reached 80° C., an aqueous mixture of ferrous sulfate and EDTA (20 g, 0.1 wt. % FeSO₄, and 2 g, 1 wt. % EDTA) was added to the flask. When the reaction mixture temperature reached 50° C., co-feeds including a solution of 1-BHP (0.9 g) and NaPS (2.5 g) mixed with DI water (68 g), along with a separate solution of IAA (1.3 g in 70 g water) were both added simultaneously to the flask at 1.25 g/mins. Two min after the start of charging the co-feed solutions, ME 2, which was prepared by mixing DI water (300 g), FES-32 emulsifier (20.0 g), n-butyl acrylate (535.8 g), methyl methacrylate (506.0 g), 2-ethylhexyl acrylate (124.4 g), acetoacetoxyethyl methacrylate (25.5 g) and methacrylic acid (8.2 g), was added to the flask over 55 min while allowing the temperature to rise to 85° C. without providing any external heat. Upon completion of co-feeds, the ME 2 addition was stopped and the batch was held for 5 min at 80° C. to 85° C.

Upon completion of the hold, 4-hydroxy TEMPO (5.0 g) mixed with DI water (20 g) was added to the flask. The remainder of the ME 2 was then fed to the flask over 5 min. NH₄OH (40.0 g, 28 wt. % aq.) mixed with DI water (40 g) was added to the flask over 2 min. When NH₄OH addition was complete, the batch was held for 5 min. Upon completion of the hold, additional co-feeds including a solution of 1-BHP (3.2 g) in DI water (36.8 g), along with a separate solution of IAA (1.8 g) in water (38.2 g) were both added simultaneously to the flask at a rate of 1.0 g/min. Twenty minutes after the start of the additional co-feeds, the emulsion was cooled to 25° C. Upon completion of addition of the second co-feed, the dispersion was filtered to remove any coagulum. The filtered opaque acrylic dispersion (OAP) had a solids content of 50.3%. The S/mil was measured to be 1.52 with collapse of 5.9%.

### Example 6—Two-Stage Preparation of an Aqueous Dispersion of Binder Coated Multistage Polymer Particles with Shell Functionalized with 40% Methyl Methacrylate

The procedure was carried out substantially as described in Example 5 except that when the contents of the flask reached 50° C., just prior to the ME 2 charge, co-feeds, including a solution of NaPS (5.0 g) mixed with DI water (109 g), was added to the flask at 2.0 g/min, along with a separate solution of IAA (1.0 g in 31 g water) added simultaneously to the flask at 1.0 g/mins. The filtered opaque acrylic dispersion (OAP) had a solids content of 49.6%. The S/mil was measured to be 1.74 with collapse of 3.9%.

### Example 7—Two-Stage Preparation of an Aqueous Dispersion of Binder Coated Multistage Polymer Particles with Shell Functionalized with 40% Methyl Methacrylate

A 5-liter, four-necked round bottom flask was equipped a paddle stirrer, thermometer, N₂ inlet and reflux condenser. DI water (600 g) was added to the flask and heated to 89° C. under N₂. NaPS (2 g in 40 g water) was added to flask immediately followed by Core #1 (125 g). ME 1, which was prepared by mixing DI water (150 g), FES-32 emulsifier (17.25 g), styrene (414.0 g), linseed oil fatty acid (2.5 g), methyl methacrylate (159.0 g), and trimethylolpropane trimethacrylate (18.0 g), was then added to the flask over 45 min. The temperature of the reaction mixture was allowed to increase to 84° C. after 30 min and allowed to increase to 92° C. after 45 min. Two minutes after the start of ME 1 addition, a solution of acrylic acid (9.0 g) in DI water (85 g) was added to the flask. Upon completion of the ME 1 feed, the reaction was cooled to 60° C.

When the contents of the flask reached 80° C., an aqueous mixture of ferrous sulfate and EDTA (20 g, 0.1 wt. % FeSO₄, and 2 g, 1 wt. % EDTA) was added to the flask. When the contents of the flask reached 60° C., co-feeds including a solution of t-BHP 1.9 g and NaPS (5.0 g) mixed with DI water (100 g), along with a separate solution of IAA, 2.6 g in DI water (55 g) were both added simultaneously to the flask over 74 min. Two minutes after the start of charging the co-feed solutions, ME 2, which was prepared by mixing DI water (290 g), FES-32 emulsifier (30.0 g), n-butyl acrylate (720.0 g), methyl methacrylate (445.8 g), acetoacetoxyethyl methacrylate (25.2 g) and methacrylic acid (9.0 g), was added to the flask over 72 min while allowing the contents to rise to 85° C. without providing any external heat. Forty-five minutes after the start of ME 2 feeds, NH₄OH (1.0 g, 28 wt. % aq.) was added to the IAA co-feed solution and NH₄OH (50.0 g, 28 wt. % aq.) mixed with DI water (50 g) was added to the flask over 20 min. Upon completion of all feeds, the batch was held for 10 min at 80° C. to 85° C.

Upon completion of the hold, additional co-feeds including a solution of t-BHP (1.5 g) in DI water (10 g), along with a separate solution of IAA (0.7 g) and sodium carbonate (0.3 g) in water (21 g) were both added simultaneously to the flask over 30 min. Upon completion of addition of the second co-feed, the emulsion was cooled to 25° C. The dispersion was filtered to remove any coagulum. The filtered opaque acrylic dispersion (OAP) had a solids content of 49.6%. The S/mil was measured to be 1.29 with collapse of 8.1%.

1. A composition comprising an aqueous dispersion of:
a) multistage polymer particles comprising 1) a water-occluded core comprising from 20 to 60 weight percent structural units of a salt of a carboxylic acid monomer and from 40 to 80 weight percent structural units of a nonionic monoethylenically unsaturated monomer; 2) a polymeric shell having a calculated T_{g} in the range of from 90° C. and 110° C.; and 3) a film-forming polymeric binder layer superposing the shell, wherein the polymeric binder layer comprises structural units of at least one monoethylenically unsaturated monomer and has a T_{g} of not greater than 35° C.; wherein:
i) at least 95 weight percent of the shell comprises structural units of methyl methacrylate, styrene, and trimethylolpropane trimethacrylate;
ii) the shell comprises from 0.5 to 6 weight percent structural units of trimethylolpropane trimethacrylate;
iii) the weight-to-weight ratio of the structural units of methyl methacrylate to styrene in the shell is in the range of from 35:65 to 55:45;
iv) the ratio of the weight of structural units of monomers of the core to the weight of the shell in the multistage polymer particles is in the range of 1:12 to 1:16;
v) the weight-to-weight ratio of the polymer binder to the sum of the weight of the shell and the weight of the structural units of monomers in the core in the multistage polymer particles is in the range of 1:1 to 3.5:1;
vi) the shell comprises less than 2 weight percent structural units of acrylonitrile; and
vii) the z-average particle size of the multistage polymer particles is in the range of from 300 nm to 750 nm.

2. The composition of claim 1 wherein the weight-to-weight ratio of the structural units of methyl methacrylate to styrene in the polymeric shell is in the range of from 40:60 to 50:50, wherein structural units of methyl methacrylate and styrene comprise at least 90 weight percent of the polymeric shell; and the polymeric shell further comprises from 1 to 4 weight percent structural units of trimethylolpropane trimethacrylate, based on the weight of the polymeric shell.

3. The composition of claim 2 wherein the weight-to-weight ratio of the polymer binder to the sum of the weight of the polymeric shell and the weight of the structural units of monomers of the core in the multistage polymer particles is in the range of from 1.2:1 to 3.0:1; and wherein the polymeric shell comprises less than 0.5 weight percent structural units of acrylonitrile.

4. The composition of claim 3 wherein the binder is an acrylic or styrene-acrylic binder having a calculated T_{g} in the range of from −20° C. to 25° C.; wherein the polymeric shell comprises less than 0.5 weight percent structural units of divinyl benzene, and less than 0.1 weight percent structural units of acrylonitrile.

5. The composition of claim 4 wherein the binder is an acrylic binder comprising structural units of n-butyl acrylate, methyl methacrylate, and methacrylic acid or acrylic acid; wherein the multistage polymer particles comprise 0 weight percent structural units of acrylonitrile and 0 weight percent structural units of divinyl benzene.

6. The composition of claim 4 wherein the binder is an acrylic binder comprising structural units of n-butyl acrylate, methyl methacrylate, acetoacetoxyethyl methacrylate, methacrylic acid or acrylic acid, and 2-ethylhexyl acrylate, wherein the multistage polymer particles comprise 0 weight percent structural units of acrylonitrile and 0 weight percent structural units of divinyl benzene.

7. The composition of claim 1 which, when applied to a substrate and allowed to dry, has a Kubelka-Munk scattering coefficient of at least 1.2 S/mil, and a collapse of less than 10%.

8. The composition of claim 3 which, when applied to a substrate and allowed to dry, has a Kubelka-Munk scattering coefficient of from 1.5 S/mil to 2.5 S/mil, and a collapse of less than 10%.

9. The composition of claim 1 which further includes one or more components selected from the group consisting of binders, inorganic opacifying pigments, coalescents, rheology modifiers, surfactants, defoamers, and extenders.
